(19) United States
(12) Patent Application Publication
(10) Pub. No.: US 2026/0007964 A1
(43) Pub. Date: Jan. 8, 2026

(54) SYSTEMS AND METHODS OF DYNAMIC GAMEPLAY INTERACTION USING RECORDED STATE DATA

(71) Applicant: NINTENDO CO., LTD., Kyoto (JP)

(72) Inventors: Jonathan BRYANT, Bellevue, WA (US); Brandon DULYEA, Redmond, WA (US); Kees LUYENDIJK, Redmond, WA (US); Rory JOHNSTON, Bellevue, WA (US)

(21) Appl. No.: 19/223,698

(22) Filed: May 30, 2025

Related U.S. Application Data
(60) Provisional application No. 63/667,072, filed on Jul. 2, 2024.

(51) Int. Cl. A63F 13/52

(52) U.S. Cl. CPC A63F 13/52

(57) ABSTRACT

A multiplayer game system is provided that allows each client to simulate aspects of a multiplayer game. Updates are communicated between clients and a server. Previously recorded state data is used to control one or more event objects within the multiplayer game. In some examples, a dynamic action may be triggered for the event object when a triggering condition is satisfied.

### CROSS REFERENCE(S) TO RELATED APPLICATION(S)

This application claims priority to U.S. Provisional Application No. 63/667,072, filed Jul. 2, 2024, the entire contents of which are hereby incorporated by reference. The contents of U.S. application Ser. No. 18/461,092, filed Sep. 5, 2023, and U.S. application Ser. No. 18/461,061, filed Sep. 5, 2023, are each incorporated by reference in their entirety.

### TECHNICAL OVERVIEW

The technology described herein relates to multiplayer video game systems. More particularly, the technology described herein relates to multiplayer video game systems that also include computer-controlled objects that are based on previously recorded state data.

### INTRODUCTION

Multiplayer video games that support online multiplayer can be technically challenging to implement. Problems such as network latency, packet loss, and other considerations can result in varied experiences for each player participating in the game. In some instances, it can be beneficial for such online multiplayer games to include objects that are controlled by a computer (e.g., rather than a player that is participating in the current game). However, implementation of such computer-controlled objects within a multiplayer video game can be challenging—especially when it is desired that such computer-controlled objects perform in a manner similar to that of other player-controlled objects.

Accordingly, it will be appreciated that new and improved techniques, systems, and processes are continually sought after in these and other technical areas.

### SUMMARY

In certain example embodiments, a multiplayer game system is provided that allows for each client to simulate aspects of a multiplayer game. Updates are communicated between clients and a server. In certain cases, previously recorded state data may be used to control one or more objects within the multiplayer game. In some examples, a dynamic aspect may be added to the objects that are controlled using previously recorded state data.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 is a wireframe view of a multiplayer video game according to certain example embodiments;

FIG. 2-4 are successive wireframe views of the multiplayer video game shown in FIG. 1 that show a non-player car dynamically interacting with another car according to certain example embodiments;

FIG. 5 is a system diagram that illustrates how the multiplayer video game shown in FIG. 1 may be implemented using a client-server architecture according to certain example embodiments;

FIG. 6 shows an example of data that may be recorded, stored, and then used in a subsequent multiplayer video game according to certain example embodiments;

FIG. 7 is a signal diagram that illustrates communication between a client and server during execution of an instance of the multiplayer video game shown in FIG. 1 according to certain example embodiments;

FIG. 8 is a flow chart of a process that may be executed on a server computer system for the multiplayer video game shown in FIG. 1 according to certain example embodiments;

FIG. 9 is a flow chart of a process that may be executed on a client computer system for the multiplayer video game shown in FIG. 1 according to certain example embodiments; and

FIG. 10 shows an example computing device that may be used in some embodiments to implement features described herein.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

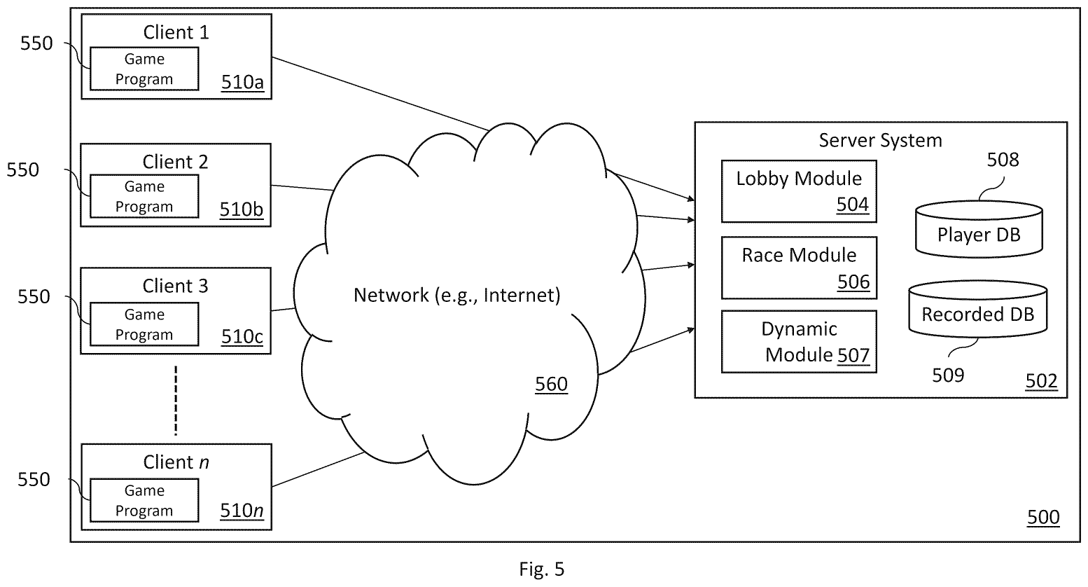

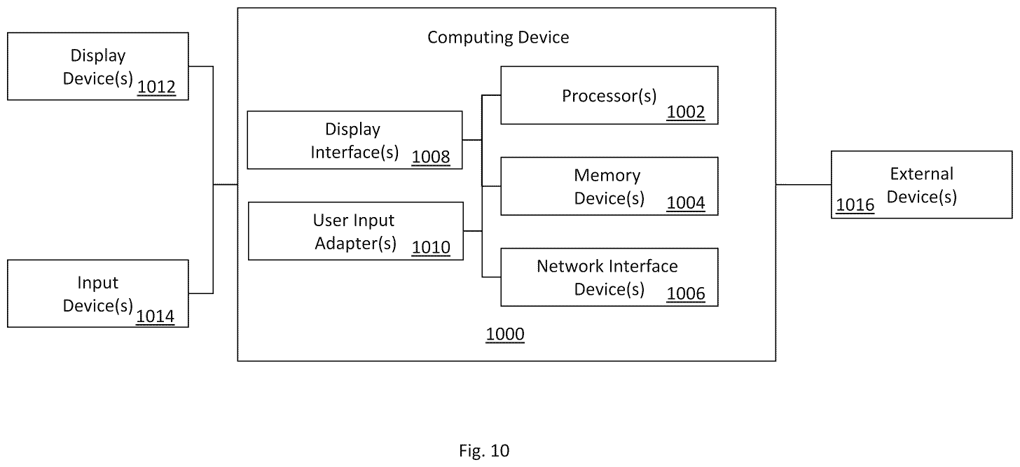

In many places in this document, including but not limited to the description of FIG. 5, software modules, software components, software engines, and/or actions performed by such elements are described. This is done for ease of description; and it should be understood that, whenever it is described in this document that a software module or the like performs any action, the action is in actuality performed by underlying hardware elements (such as a processor, hardware circuit, and/or a memory device) according to the instructions that comprise the software module or the like. Further details regarding this are provided below in, among other places, the description of FIG. 10.

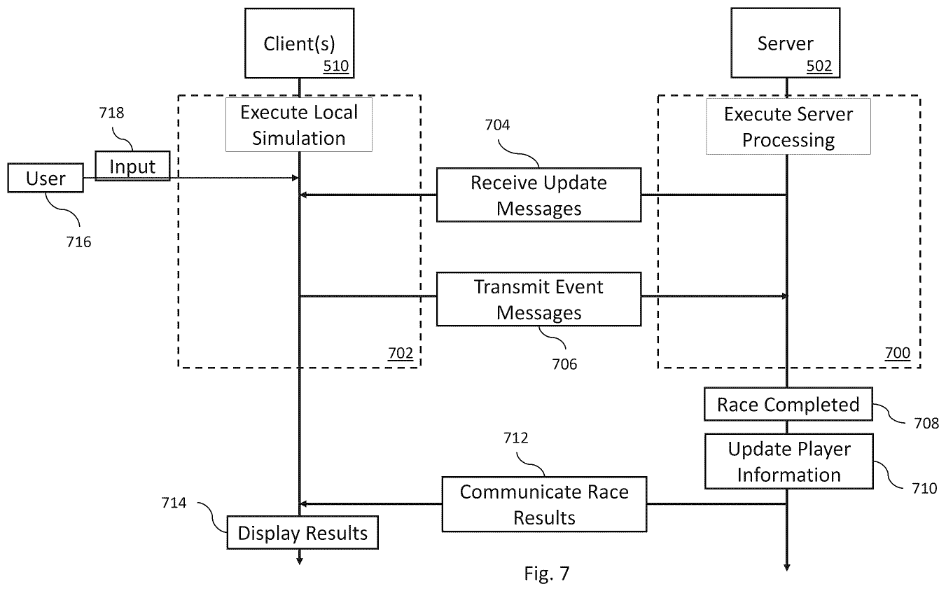

Some reference numbers are reused across multiple Figures to refer to the same element; for example, the server system 502 first shown in FIG. 5 is also referenced and described in connection FIG. 7.

### Overview

In certain example embodiments, an online multiplayer racing game is provided. Tens or even a hundred or more different users may participate in the race in certain examples. The users compete within a virtual space (e.g., a virtual game space) as they control their respective player-controlled objects (e.g., which may be referred as a “vehicle” elsewhere herein) around a track that is located within the virtual space. Each user operates their own computing device as a client that communicates (e.g., via the Internet or other electronic data network) with a server or other host computer system that provides communication updates to the clients that are participating in the multiplayer game.

In some example embodiments, an event object (e.g., an event vehicle) may be added to the race. The event object may be based on a set of previously recorded state data (e.g., a recording of a prior instance of the game). The previously recorded state data is used to control the state of the event object during the multiplayer game. The event object may be designed to allow players to compete against it (e.g., to see if they can get a better race time). While the previously recorded state data is used to control a substantial portion of the performance of the event object during the game, additional dynamic actions may be triggered for the event object.

In certain instances, the state of the event object may differ between a local simulation running on a client system and the simulation running a server. In such cases, the client system may use interpolation in order to guide the current state of the event object on the client towards the state for the event object that has been communicated from the server. This additionally allows for the event objects to be more dynamic than strictly adhering to the previously recorded state data as they can also interact with other objects (e.g., players) that are participating in the multiplayer game.

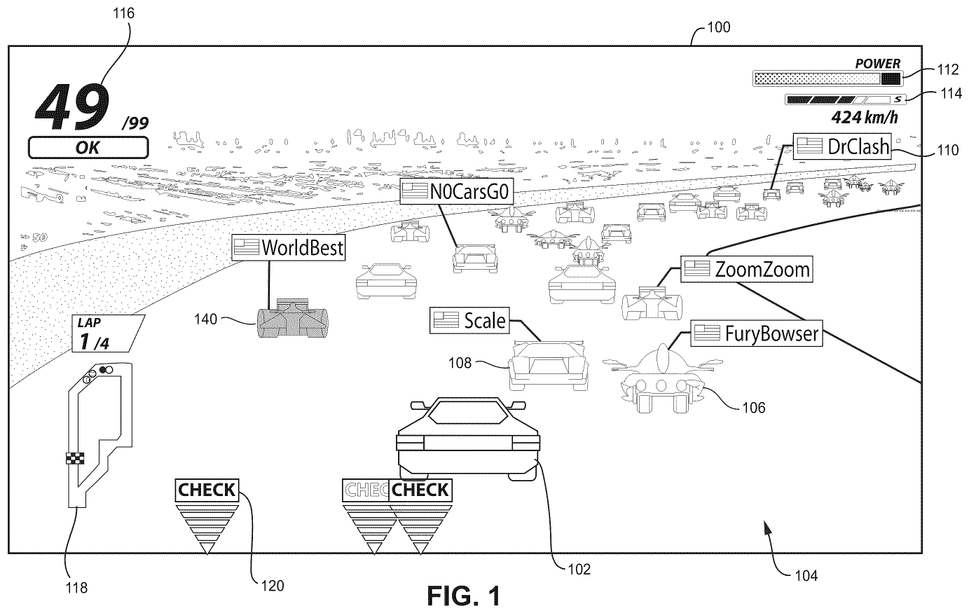

### Description of FIG. 1: Example Gameplay

FIG. 1 is a wireframe view 100 showing different aspects of an example multiplayer video game. As shown in FIG. 1, a race game is used as an example of the multiplayer video game that may be implemented in certain example embodiments. While the techniques herein are discussed in connection with an example racing game, they may also be applied to other types of games that involve multiple players. In certain examples, the techniques may also be applied in single player games (for example with one or more computer-controlled opponents).

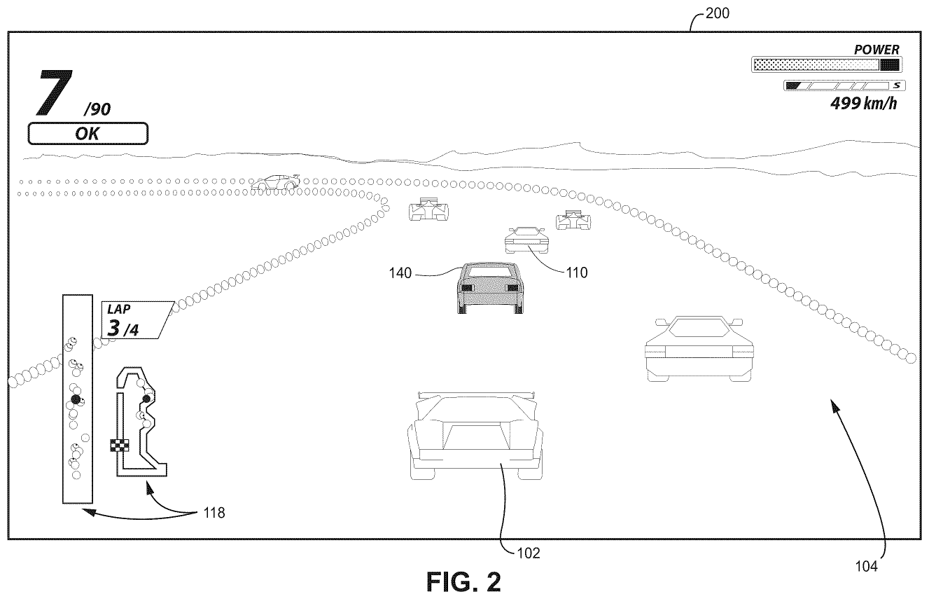

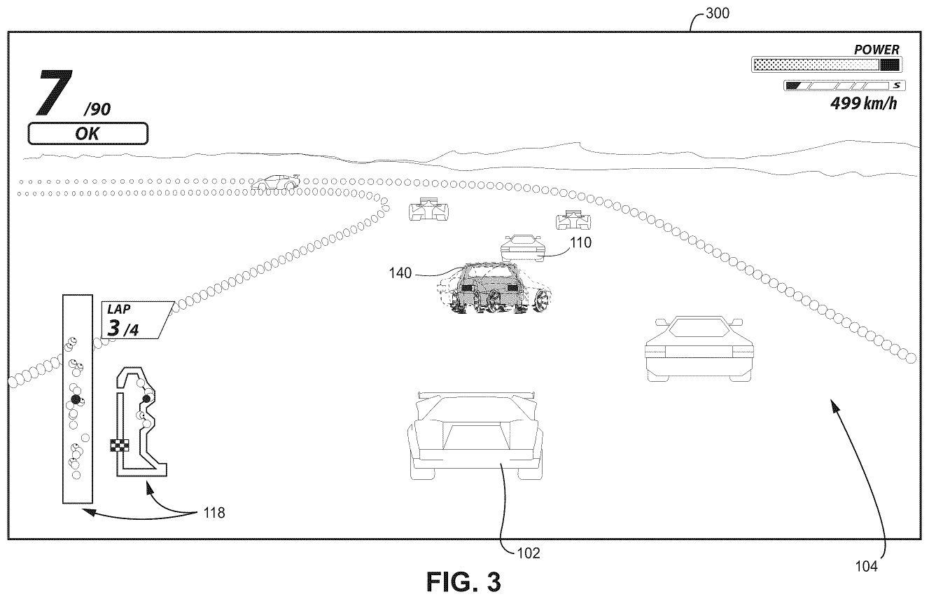

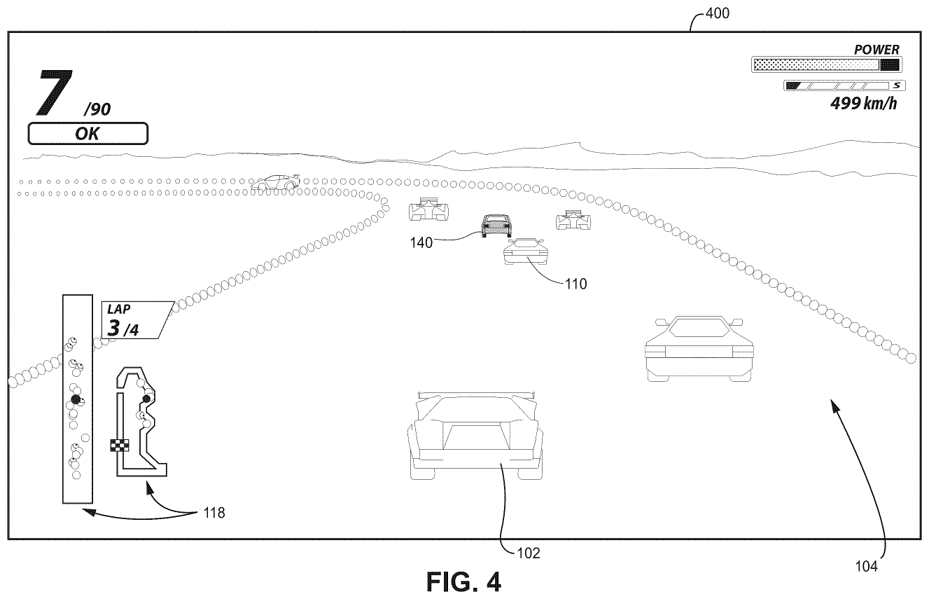

In certain example embodiments, the illustrative racing game discussed herein allows tens or even a hundred or more users to participate and compete within the same virtual space. FIG. 1 is a wireframe view 100 based on an image generated as part of an online multiplayer racing game where users race against one another around the track 104 that is in the virtual game space. The images (image 100 in FIG. 4, image 200 in FIG. 2, image 300 in FIG. 3, and image 400 in FIG. 4) may be generated by a computing device 1000 that is used by a user to participate in the multiplayer video game. The generated images may be displayed on display device 1012 that is coupled to the computing device 1000.

The multiplayer racing game shown and discussed herein is implemented with a three-dimensional virtual space. However, it will be appreciated that while certain examples herein are discussed in the context of three-dimensional virtual spaces, that the techniques may be applied to games that are in other than a virtual three-dimensional space. For example, a multiplayer video game with two dimensions (e.g., a side-scroller or the like that has little or no z-axis) may be implemented in certain example embodiments.

Image 100 includes heads up display elements that are part of or overlaid with a rendered view of the virtual game space that includes track 104, a player-controlled virtual object 102 that is controlled by a player playing the multiplayer video game on the computing device 1000 on which the local simulation is executing (and a user providing input thereto), and additional virtual objects.

The track 104 within the virtual game space may include various obstacles, jump pads, speed boost areas, and the like. In general, the multiplayer game may be played by having players race multiple times around a given track (e.g., as shown in FIG. 1 with “Lap 1/4”).

Additional virtual objects may include virtual objects 106 and 108 that may be controlled by other players (described elsewhere herein) or may be non-player-controlled objects (also called non-player characters or “NPCs” herein). The additional virtual objects may also include an event non-player-controlled object 140 (sometimes called an “event object” herein). Event objects may also be a type of NPC object (e.g., such that they are not directly controlled by other users).

In the example shown in FIG. 1, vehicles shown in the race may be controlled by other users using their own computing device 1000. Player-controlled objects may be differentiated from NPC objects due to player-controlled objects being responsive to input from a corresponding player. In contrast, the movement, actions, etc. of NPC objects may be controlled with a computer program, script, or other data (e.g., programmatic control) without relying on input from a user. In some examples, the control of such NPC objects may be handled by respective clients and/or via processing executing on the server system, which then communicates how the NPCs should be controlled to the respective clients.

In some examples, a vehicle that is participating in a race may be an NPC vehicle. For example, if there are 50 vehicles in a race, 10 may be NPC vehicles. NPC vehicles may be referred to as AI players herein. Indeed, in instances where another player is described within the game, that other player may be an AI player, or may be a player that is controlled by a user of another computing device. From the perspective of each user that is controlling their own respective vehicle 102, whether another vehicle is ultimately controlled by another user or is an AI player may be indistinguishable. In some examples, NPC vehicles/AI players may be identified as such (e.g., via the name they use, or how they are identified within the game).

Note that for ease of description, the term “vehicle” is used interchangeably with object, player-controlled object, and other virtual objects that may be located with the virtual game space discussed in connection with the illustrative examples herein. It will be appreciated, however, that different types of objects may be used according to certain examples. For example, the player-controlled object may be a player character or a non-vehicle object (e.g., a horse, dinosaur, or other type of animal). In general, a player-controlled object is an object for which a user provides input (e.g., via input device 1014 of FIG. 10) to control on or more attributes (e.g., direction, speed, abilities, such as a special power, and the like) of the corresponding player-controlled object.

In certain example embodiments, player-controlled objects may include objects that are computer controlled (such as by the server)—these players may be referred to as AI players.

As discussed in greater detail herein, another type of object that is participating in the multiplayer game may be an event object(s) 140. These may be controlled based on a combination of previously recorded state data (e.g., stored in recorded DB 509) and a dynamic event module 507 that is used to dynamically trigger the event object 140 to take one or more types of actions based on a current condition to state of the race, virtual space, or other data. An illustrative example of an action that may be triggered for the event object 140, may be to cause the event object to perform a spin move, to jump, to move laterally (e.g., sidestep), to activate a special ability, to activate a speed boost, or others. Any or all of these actions may be dynamically triggered based on, for example, the current state of the multiple player game and/or objects therein.

In certain examples, event objects may be identified as such within the game. For example, event object 140 may be visually identifiable (e.g., because the vehicle glows, is outlined differently, or has a different color). Making event object 140 visually distinguishable can allow participating players (such as the user controlling player objects 102) to recognize the event object within a race. This can be advantageous as users may desire to compete against the event objects within the multiplayer game.

In some examples multiple event objects may be provided in a race and each be based on or associated with their own respective recorded state data.

Returning to image 100 shown in FIG. 1, the image may include heads-up display elements that are provided to the user (e.g., to provide additional information content to the user playing the video game). These heads-up display elements may include, for example, a display element 116, a power meter 112 (or health meter), a charge meter 114 for a special ability, mini-map icon 118, check icons 120, an indicator of the speed the player-controlled object 102 is moving in the race (424 km/h in the FIG. 1 example), etc.

Display element 116 is used to show the ranking of the player-controlled object within the race. For example, in FIG. 1 the player-controlled object is at position 49 out of 99 positions within the race. In some examples, display element 116 may include additional information, such as the current race, which race of multiple different races is currently active (e.g., as part of a racing circuit competition), etc.

In some examples, display element 116 may also include a notification (e.g., “OK”) that can be used to indicate whether or not the player and their vehicle 102 is within a cut line that is used over a series of races (or laps). If the player is within the cut line, then they are positioned to advance to a subsequent race, if they are outside the cut line, then they may not advance to the next race. In some examples, the cut line may be used on a per lap basis (e.g., each lap or every other lap, etc.) of a race. In such cases, the player and their vehicle may be removed from the race if they are not within a cut line. As an example, a cut line may be set at 70 (so the top 70 players advance). If a cut line of the top 70 is used, then the OK notification is displayed. Otherwise, another notification that indicates the player is below the cut line may be displayed.

Power meter 112 shows a graphical indication of a health attribute of the vehicle. This is used to provide an indication of health or durability of the vehicle to the user. In certain examples, the health of a vehicle may be decreased when the vehicle collides with another vehicle in the race. In some examples, the health meter may also be used to temporarily boost the top speed of the vehicle within the race (e.g., a turbo boost). In some examples, while the boost ability is active, the health of the vehicle may be gradually depleted.

Charge meter 114 is used to indicate a level of charge of a special ability parameter. When the meter is fully charged, then the player may activate/trigger a special ability. Additionally details of the special ability parameter are discussed in U.S. application Ser. No. 18/461,061, the entire contents of which are hereby incorporated by reference.

The mini-map 118 shows a miniature version of the track and may, in some examples, separately identify (e.g., by color, shading, icon etc.) where the player-controlled object is in the race, where any rivals are located, which object is in first place, where any or all of the event objects are located, where the object that is in first place is located, etc. Different vehicles (non-player-controlled vehicles, rivals, the player-controlled vehicle, other player-controlled vehicles, etc.) may be identified differently by using different colors, shadings, or other visual indicators. For example, the icon in the mini map that corresponds to vehicle 102 may be green, non-player objects gray, rivals red, other player vehicles blue, and event objects as a glowing red. In some examples, there may be multiple mini maps that are displayed (as shown in FIGS. 2-4). For example, one mini map may be linear while the other may show a top-down view of a course (e.g., as shown in FIG. 1). In some examples, a user may switch between multiple different types of mini maps.

Check icons 120 is used to indicate to a player when other vehicles within a race are behind vehicle 102. In some examples, the icons may flash or blink as a vehicle moves “closer” to the player-controlled object 102. In some examples, different animations or colors may be used to indicate if the vehicle behind is moving closer or further away. In some examples, the color of the check icon may correspond (or be the same as) the color of the object as shown in the mini map.

In some examples, the heads-up display elements may include player icons 110 that identify the player associated with other player vehicles within the race. In some instances, player icons 110 may be, for example, the player name associated with the user controlling the corresponding vehicle. NOCarsG0, ZoomZoom, FuryBowser, Scale, DrClash, and WorldBest are examples icons that display the usernames, player names, or character names of the other players that control vehicles within the race shown in FIG. 1. In some examples the icons may include the flag associated with where that user is playing the multiplayer video game. In some examples, a virtual object that is labeled with an icon may be a non-player-controlled object. For example, WorldBest may be an event object and the name “WorldBest” may be the name of the user/account/or other that originally generated the previously recorded state data for that event object. In some examples, an event object, and the player icon associated therewith may be identified differently from other types of icons. In some examples, each object that is participating in the race may be identified by a corresponding icon. As an example, each of the vehicles may, in some examples, have a corresponding icon that identifies the player (or type of object) associated with that vehicle. In some examples, a subset of the vehicles in a race may have a correspondingly displayed player icon. For example, the object that is leading the race and, for example, the five objects closest to the position of the player-controlled object 102 within the race may be displayed with an icon. Accordingly, the icons may be dynamically updated as the race progresses. In some examples, the icon for one or more objects may be continually displayed while others are dynamically adjusted. For example, the icon for WorldBest may be continually displayed because it is an event object. In contrast, the icons for Scale and FuryBowser may be adjusted as the corresponding objects move away/closer to/from the player-controlled object 102.

### Description of FIGS. 2-4: Event Objects

In certain example embodiments, and as discussed herein, a multiplayer game may include one or more event objects. When a new race is started (such as described in connection with U.S. application Ser. No. 18/461,061), it may be determined (e.g., by system 500 and/or server 502), whether an event object should be included into the race. An event object may be, for example, one (or more) of 10, 20, or 99 different vehicles that may be included in the race that is to be performed.

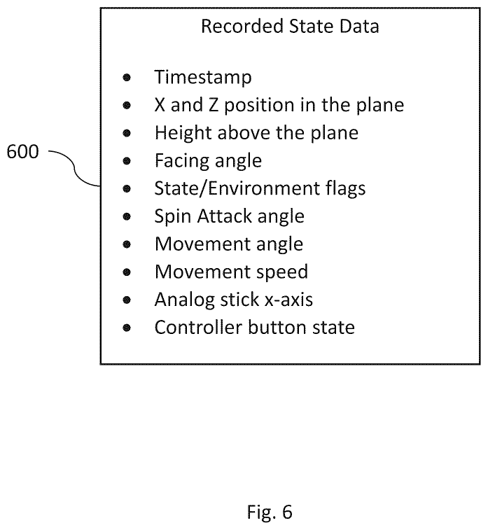

Unlike player-controlled objects and/or other types of NPC objects, the control of event objects is based on previously recorded state data (discussed in greater detail herein). Such data may be referred to as “ghost data” in some examples. Recorded state data is based on a recorded prior performance in which various attributes (e.g., position, speed, etc.) are recorded for the object as it progresses through the game space (e.g., a racetrack). An example of the type of data that may be recorded is shown in FIG. 6.

In some examples, the recording may have been generated during another instance of a race. For example, in a prior instance of the multiplayer game the player “FuryBowser” may have competed and recorded a race, which is now being used to control (or guide) an event object in the current race. In some examples, such a recording may be generated in a solo, “offline”, or practice mode (e.g., there are no other players or other vehicles on the track). In some examples, recorded state data may be generated by, for example, a developer or other “expert” of the video game. This can allow playing users to play “against” the recorded data of the developer or other expert. As the data is recorded it can be used in many different races—even those that are occurring at the same time. For example, the server system can provide different instances of the same multiplayer game to users around the world. For example, 500 different races may be performed at the same time (with each race including about 100 different players). The same event object may be used in each of the 500 races. However, while the same event data may be used in each race, how the event object progresses through each instance may be different due to, for example, the triggering of dynamic actions and the like that are discussed herein.

In some examples, the recorded state data may be generated by other users. This may allow, for example, users to “compete” against users they would not normally play against (e.g., due to time zone differences, etc.). In any event, the recorded state data may be saved during one instance of a race/game, and then loaded for use in a subsequent race instance of the game.

FIGS. 2 through 4 are wireframe views that illustrate how event objects (e.g., event object 140) may be displayed and processed in connection with certain example embodiments.

In FIGS. 2-4, movement and other control of event object 140 is performed based on the previously recorded state data. In other words, the state (e.g., placement, speed, etc.) of event object 140 shown in FIG. 2 within the multiplayer game at time (t) (e.g., from the start of the race) may be the same as, or correspond to, the state of a corresponding prior object at time (t) from a prior instance of the race. This is because the server controls the event object 140 based on the recorded state data for that prior object. In contrast, player objects 110 & 102 are controlled based on input from players participating in the race (e.g., without reference to previously recorded state data).

In certain instances, in combination with control based on the previously recorded state data, dynamic control of the event object 140 may be performed during a race. For example, while the race is ongoing a process may determine if a triggering condition for the event object has been met. If such a triggering condition is met, then an action may be triggered that dynamically controls the event object 140 to perform operations that are different than those in the previously recorded state data.

An illustrative example of such a triggering condition and a corresponding action is shown in FIG. 3. In FIG. 3, the triggering condition is when another object is within a given distance of the event object 140. In this case, object 110 is determined to be located in the virtual space within a threshold distance of where the event object is located within the virtual space. When such a determination is made, then the event object is caused to perform the corresponding action for that triggering condition. As shown in FIG. 3, event object 140 performs a spin action. Note that the performance of the spin action is not based on the previously recorded state data. Instead, it is dynamically triggered based on player-object 110 coming too close to event object 140.

In some examples, the spin action may cause any nearby objects (e.g., object 110) to be pushed away from the event object. This can be used to, for example, either avoid being attacked (e.g., via a collision) by another object or to perform an attack on another object (e.g., that decreases the health or other attribute of the other object).

Various types of triggering conditions may be checked or otherwise monitored throughout a race. Conditions may be based on one or attributes of the race, other objects in the race, or other aspects. For example, a triggering condition may be that the event object (or another object) has low health, that the event object (or another object) has exceeded a certain speed, that the event object (or another object) is at a certain placement in the race, that the event object (or another object) is on the last lap (or nth lap) of a race, that an object has enter the final lap of a race, that the race is on the first lap, that there are less than a threshold number of objects remaining in the race, etc.

As noted above, a type of action that may be triggered may be a spin attack or a spin move. Other types of actions that may be triggered in accordance with certain example embodiments may be a jump action, a brake activation, a slide action, activation of a special power or special move, or any other type of action or status change that may be dynamically triggered for the event object.

An additional aspect related to the event object 140 is that it is interactable with other objects (102/104/106, etc.) are participating in the race in which the event object 140 is participating. As a result, the performance of the event object in one race may not necessarily exactly match the performance in the original race that was used to generate the state data.

As an illustrative example, collisions may occur between event object 140 and other objects within a race. The results of such collisions (e.g., changes in positions, speed, direction, and the like for the event object) may be handled via collision detection processing that is performed dynamically throughout the race. In such cases, the state of the event object 140 may be changed so that it no longer matches that of the recorded state data. For example, in screen 400 of FIG. 4, event object 140 may be further along in the race than the corresponding previously recorded state data (at time t). For example, the current position of event object 140 within the race may be further along because of the triggered spin move that is shown in FIG. 3 or some other action that occurred dynamically within the current multiplayer game.

In some examples, interpolation may be used to control the state of objects within a race. In the context of event objects, if the current position of event object 140 is “10” (at time t), but the recorded state data for the event object indicates that the event object should be at position “9” (at time t), then interpolation may be used to move the event object closer to the location indicated by the previously recorded data. For example, over the next 12 frames (or other time period), the current location of the event object may be gradually moved towards the previously recorded location. This may be used instead of immediately moving the event object to “9”. This approach of using interpolation can also allow for the previously recorded state data to influence how the event object performs within a given race, while also allowing for more dynamic interaction with the event object during a given race. In other words, even though the same previously recorded state data may be used for the same event object in, for example, 100 different races, each race may play out slightly differently depending on the performance of the players in that race and their interactions with the event object. For example, the triggering of an action that causes additional movement may occur in one race, but not in another race.

In certain example embodiments, the interpolation algorithm that is used may be programmed to cause the current position of an event object to be adjusted so that the event object completes the current race in the same (or about the same) amount of time that it took the previously recorded object to complete the race. Thus, for example, if the event object moves ahead of where the previously recorded data indicates it should be, then it may be controlled (e.g., via interpolation) to not move further ahead. Instead, it may be controlled to gradually match the state information of the previously recorded state data.

In certain example embodiments, processing for event objects may be performed differently on the server versus each of the clients that are participating in a given race. More specifically, processing on the server may be performed such that the event object is simulated using the previously recorded state data to make the event object recreate the original race almost exactly as it was played. In some examples, the event data that is processed by the server does not process or handle collisions or other interactions with other objects. However, collision detection processing may be performed for the event objects for each of the clients.

State data for the event object 140 may be communicated to all of the clients participating in the race (e.g., each controlling their own object with the race). Each of the clients may receive the state data for the event object and perform a local or client-side simulation of the race using this information. This simulation may be different from that performed on the server in that collision detection processing and the like may be performed. Such client-side processing may then cause the position or other state attributes of the event object 140 to be changed from those on the server. In certain example embodiments, each of the clients may then attempt to re-synchronize the state of the event object on the client with the state of the event object as provided from the server by using interpolation. This allows the “correct” state of the event object to be gradually matched on the client to that on the server. Additional details for how such synchronization can be handled are discussed in greater detail below.

### Description of FIG. 5: System

Turning now to the computer architecture provided to enable the multiplayer video game to be played by users, FIG. 5 is a system diagram that illustrates how the multiplayer video game shown in FIGS. 1-4 may be implemented in a client-server architecture according to certain example embodiments.

System 500 includes a server computer system 502 (also referred to as server 502 herein) that communicates with a plurality of computing devices 510 (e.g., 510a-510n) that are each configured to execute an instance of game program 550. Game program 550 may be provided on a disc, cartridge, or may be downloaded to a corresponding computing device over a network (e.g., the Internet). In some examples, the game program is associated with an account for the user. This account may include a player name or the like, which is then displayed within the multiplayer video game. For example, “Scale” may be the account or player name for vehicle 108 that is shown in FIG. 1.

There may be hundreds or even thousands of such computing devices 510 in communication with server 502 and there may be, for example, one hundred such computing devices participating within the same instance of the multiplayer video game. Each of the computing devices acts as a client that communicates with server computer system 502.

As discussed in connection with the various signal diagrams herein, computing devices 510 communicate with the server system 502 via a network 560. In some examples, network 560 may be, for example, the Internet where communication may be performed between the client(s) 510 and server system 502 using, for example, UDP/IP for transmitting state data of an executing game. In other examples, network 560 may be a local area network or a private network (including virtual private networks (VPNs)).

Each client (e.g., client 1, client 2, client 3, through client n) communicates with the server system 502 to send and receive data in connection with the multiplayer video game. The data may include data for joining a game, state data for when a game is executing (e.g., as discussed in connection with FIGS. 6 and 7), and other types of data. Other types of data that may be communicated may include voice data (e.g., VoIP), textual data for in-game messaging or the like, and other data that can be used in connection with the multiplayer video game discussed herein.

In certain examples, a client-server technical architecture may be used with the server 502 being dedicated to receiving and providing updates to clients (e.g., without having to rely on rendering images or the like). Such a technical architecture may be beneficial due to the number of clients (e.g., up to 100 for example) that can participate in a given race. With this type of architecture, clients can send and receive data packets to/from the server 502 without having to directly communicate with the other clients. While other types of network architectures may be employed in certain examples, it will be appreciated the other such architectures (e.g., peer-to-peer, or the like) may come with downsides in terms of performance and/or overhead. However, depending on application need, such other networking architectures may be used in certain example embodiments.

In certain example embodiments, updates to the clients can be provided in batches. For example, each client may be allocated to one of a plurality of different groups. And updates may be provided to clients within each group on a frame-by-frame basis. For example, clients in group 1 may receive updates from server 502 for frame x (and every nth frame thereafter). Clients in group 2 may receive updates from server 502 for frame x+1 (and every nth frame thereafter). And clients in group 3 may receive updates from server 502 for frame x+2 (and every nth frame thereafter). Accordingly, for example, clients each group may receive updates every nth frame—e.g., if there are 6 groups, then each client may receive updates every 6 frames of execution. Thus, as an illustrative example, if the server executes a simulation at 60 frames per second, then the server may transmit 10 updates per second to each client.

### Client 510

Clients 510a-510n (generally referred to as client 510 herein) each operate on, or correspond to, a different computing device. Illustrative examples of a computing device on which a client may operate are discussed in connection with FIG. 10. Some computing devices may be personal computers, others may be mobile devices, others may be dedicated game devices. In some examples, a client can be hosted within a virtual machine or a virtual instance (e.g., a Docker container or the like). In such cases, a given computing device may host multiple clients that each operate separately. As shown in FIG. 5, each client 510 executes a different instance of game program 550 on a corresponding computing device. The game program 550 (e.g., an executable, such as an .exe for example) may be stored in memory device(s) 1014 (such as non-volatile storage) and loaded into RAM/other volatile storage for execution. The game program may be executed by one or more processors of the corresponding computing device in connection with performance of the functionality of the multiplayer video game described herein.

Each client 510 processes input provided by a user via, for example, input device(s) 1014 that are coupled to the corresponding computing device. In some examples, and as discussed in greater detail below, input may be processed by the corresponding client and then the results of that processing (e.g., updates to how an object has been controlled or changed) may then be communicated to server system 500. In other examples, the input (e.g., that a particular button has been pressed, the state of a button, the state of a joystick, a sensed quantity from a sensor, etc.) may be communicated to the server 502, which may then perform processing based on that input.

In certain examples, each client that is part of system 500 corresponds to a different player within the multiplayer game. However, in some examples, a given client may process input (and other aspects) for multiple players. For example, a given client may allow two users to provide input via different input device(s) 1014 or the like that are both coupled to the same computing device. Such an implementation may be similar to split screen modes in other types of video games. The provided input is then used to update the vehicles associated with those respective players (and/or directly communicated to the server 502) and then the updates to those vehicles may be communicated to the server system as discussed elsewhere herein.

In general, clients and computing devices are provided on a 1-to-1 basis such that each client is supported by a corresponding computing device. However, in some examples, multiple clients may execute on the same computing device. As an illustrative example, a computer may execute two instances of game program 550. For example, multiple clients may be provided via a cloud-based streaming service that processes input provided to a thin-client that is located with the user controlling a corresponding vehicle being processed by such a cloud-based stream service.

### Server 502

Server system 502 may be composed of one or more of the computing devices 1000. The server system 502 may be responsible for allocating players to instances of the multiplayer video game, conducting/executing each instance, providing post-race functionality, and other aspects as needed. The server system 502 includes Lobby Module 504 and Race Module 506 to provide this, and other, functionality in connection with the multiplayer video game.

Lobby Module 504 is responsible for handling connection requests from clients, generating lobbies (e.g., determining which clients are to participate within a given instance of a race), and matching or otherwise placing clients and their players into instances of the multiplayer video game. The creation of new instances of the multiplayer video game is discussed in further detail in connection with U.S. application Ser. No. 18/461,061, the entire contents of which being hereby incorporated by reference.

Each new instance of a race of the multiplayer video game may be handled via Race Module 506. The Race Module 506 is responsible for executing races and handling communication to/from clients 510 that are participating within a given race. For example, the Race Module 506 may be responsible for receiving updates to the positions of vehicles from each client and then, for example, determining a winner (e.g., which vehicle crosses the finish line first, etc.). In some examples, the Race Module 506 may include functionality for controlling NPC vehicles. In some examples, the Race Module 506 may execute processing that includes starting a new virtual container instance (e.g., a docker container, virtual machine, or the like) to host the executing each instance of the Race Module 506. This allows, for example, multiple different races to occur simultaneously and thus allows thousands or more users to participate across many different races that may be operating concurrently (but separately from one another) on the server 502.

In some examples, and in connection with providing functionality associated with one or more event objects that may be present within a race, a dynamic module 507 may be provided. The dynamic module 507 is responsible for testing whether one or more triggering conditions for an event object have been satisfied and then, if so, injecting or otherwise communicating to the race module 506 that the corresponding action for that triggering condition can be performed for the event object. In some examples, and as discussed herein, the triggering of the action may be dependent on not having a cooldown timer for that action being currently active. In other words, when an action is triggered via the dynamic module 507 (or elsewhere), a cooldown timer may be activated. While the cooldown timer is active, the race module 506 and/or the dynamic module 507 may suppress or ignore additional activations for the action—even if the triggering condition is satisfied. Accordingly, activation of the corresponding action for the event object may require: 1) activation of the triggering condition; and 2) not having a currently active timer for that action (or the triggering condition associated therewith). The use of the cooldown timer allows for control of how often the corresponding action may be performed by the event object.

In some examples, the cooldown timer may be a set duration (e.g., 10 seconds). In other examples, a randomization factor may be added to the cooldown timer (e.g., 10 seconds+/−any time within 2 seconds). In other examples, a timer duration value between an upper (e.g., 20 seconds) and lower bound (e.g., 5 seconds) may be used for the timer duration.

In certain example embodiments, the action that may be triggered by the server may also be an action that is triggerable by a user for their player-controlled object 102. In other words, the same action may be performed by player-controlled object 102 and event objects. In some examples, the user version of the action may also be associated or controlled based on a cooldown timer. In some examples, the duration of the cooldown timer for a user may be fixed at the same duration (and the same for all users). In contrast, the duration for a cooldown timer for the event object may be influenced (as discussed herein) by an additional randomness factor (e.g., the duration being+/−5 seconds from 30 seconds).

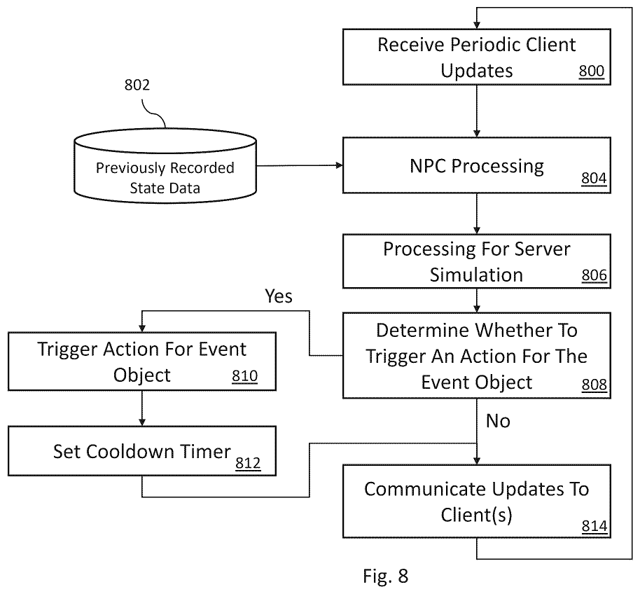

The server system 502 also includes or communicates with a player database (Player DB) 508. The player database 508 stores a skill rating for each player and other game result data for players that participate in the multiplayer game. In some examples, information in the player database 608 is used to generate Rivals for a given player. The skill rating that is stored may be, for example, calculated using the Elo, Glicko, or Glicko 2 rating system and adjusted based on the results of each race. Additional details regarding the processing performed by the server are provided in connection with FIG. 8.

### Description of FIG. 6: Ghost Data

The server 502 also includes one or more previously recorded instances of state data that may be stored in recorded database 509. When a race is being executed by the race module 506, state data to control the event object is loaded from the recorded database 509 and then used to determine how the event object should be controlled during the race.

In certain example embodiments, the state data that is stored in recorded DB 509 may have been generated in a manner similar to other “ghost” data. In some examples, the state data may be generated via a practice mode in which a user races around the track in a solo mode. When state data is being recorded, the data being recorded may be recorded every frame of execution, every other frame of execution, or other value, such as every 6^{th} frame of execution. The state data may be recorded from the start of the race until the object crosses a finish line. In some examples, each instance of state data may be composed of a data structure that holds one or more attributes regarding the state of the object at a given time. In some examples, state data may be stored based on either an in-game action/event occurring and/or a specific input provided by the player. For example, if the event object activates a special power, state data may be stored in correspondence with such an activation. In another example, state data may be stored when a particular button is pressed (or any button). In some examples, such state data may be stored in addition to storing state data for every predetermined period (e.g., every 6^{th} frame or the like).

FIG. 6 shows an example of the different types of data that may be stored for every instance of state data that is recorded. The previously recorded state data 600 may include a timestamp that may be, for example, a number of frames from the start of the race, an incrementing index value, or other value.

Data 600 can include positional data, such as the location of the object in the virtual game space or other positional information that indicates where the object is on the track. In some examples, this will be an X, Y location. However, in other examples, this may be a single value, or may be a three-dimensional value (e.g., X, Y, Z). Another item included may be the height above the plane in which the track is located. This may be used to record positional data when, for example, the event object is to jump or the like. Data 600 may also include orientation data. This may be, for example, a facing angle of the event object.

Data 600 may also include any state or environment flags for the event object. This may include health, powerup status, or other types of state information. In some examples, this may include information on the activation of special moves or the like.

Another item included in data 600 may be a spin attack occurrence and/or data related to such a spin attack (e.g., duration, a triggering angle, etc.). In certain example embodiments, data for a spin attack (or other action) may be stored as part of the recorded state data 600 and then triggered based on that recorded data for use by an event object. As discussed elsewhere herein, a spin attack may also be triggered dynamically (e.g., at 810 in FIG. 8). In certain example embodiments, when a spin attack is triggered based on the previously recorded state data a cooldown timer may be triggered/started.

In certain example embodiments, if the cooldown timer is already active and the previously recorded state data indicates that a spin attack is to be performed, then occurrence of that instance of the spin attack may be suppressed because the cooldown timer is still active. In certain example embodiments, a dynamically triggered instance of an action (e.g., a spin attack), and a previously recorded instance of that same action may share and/or trigger a cooldown timer. In certain example embodiments, a dynamically triggered instance of an action (e.g., a spin attack), and a previously recorded instance of that same action may each have their own cooldown timer and/or trigger their own cooldown timer. In some examples, the duration for the timers may be different. In some examples, the duration for the timer may be the same.

Data 600 may also include data that represents vector information for how the object is moving within the virtual game space. This may include, for example, a movement angle. Note that this may be a movement vector and may be different from the “facing” angle (which may be the orientation of the object). For example, the event object may be facing at 0 degrees, but moving at an angle of 180 degrees. Another item included in data 600 may be the movement speed of the event object. Note that in certain cases the recorded data 600 may include both positional and velocity data. While velocity can be calculated from changes in position, the additional recordation of velocity (in addition to position) in accordance with certain example embodiments can assist in overcoming, for example, floating point precision errors that may occur by calculating velocity using just position.

Another data item included in data 600 may be the status or state of one or more buttons or other switches on a controller. This may include the state of an analog stick (e.g., a joystick). In some examples, this may be the state along the X-axis of that stick and may be used to record whether the player is moving left or right. In some examples, the state of one or more buttons of a controller may be stored. For example, if the “A” or “L” button is currently being pressed.

In some examples, other types of data may also be recorded as part of data 600. In certain example embodiments, the type of data that is recorded may be the same and/or similar to the type of data communicated from a client to the server. This may include recordings of additional actions taken by a user during gameplay and the like.

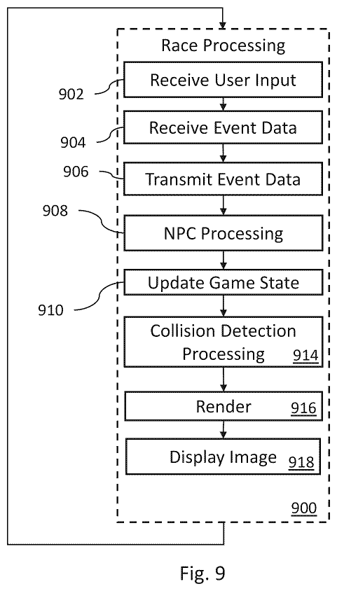

Any or all of the state data that is stored may then subsequently be used to determine and/or control how the event object is simulated during a subsequent race. In some examples, data 600 may be processed by the server (as discussed in FIG. 8) and then the results of that processing communicated to clients. In some examples, data that is communicated from the server to the clients that are participating in the multiplayer game may be the same. In other examples, some (or all) of data 600 may be communicated to clients, which may then process the data as discussed herein (as discussed in FIGS. 7 and 9).

### Description of FIG. 7: Game Processing

FIG. 7 is a signal diagram that illustrates communication between clients 510 and server 502 during execution of the multiplayer video game shown in FIG. 1 according to certain example embodiments.

When the multiplayer video game is started, each client 510 executes a copy of a game program 550. The server 502 also executes its own version of the multiplayer game (which may be a different version than the game program 550 and is used to execute the server-side simulation). Each of the executing instances on the client(s) and server is a distinct simulation of the multiplayer video game. The clients and the server communicate data messages that are used to synchronize the state of the clients to that of the server and to provide an indication of what actions a particular user (716) has taken on a given client for the server simulation. For example, the messages are used to update the respective game instances regarding changes in, for example, how a vehicle is being controlled by a user or how other vehicles have been controlled by other users.

As an illustrative example, a given client 510 may communicate information regarding the speed and position of the vehicle being controlled (via input 718) by the user (716) to the server 502. The server receives such messages from all clients and then communicates, to each client, updates regarding all of the other players (and their respective vehicles) within the game. The various clients receive those messages and then update their local client-side simulation based on the data in those messages (in addition to any input provided by the user of the computing device). However, some processing (or the results of such processing) performed on clients (or the server) may not be communicated. As example of such processing may be the results of collision detection processing that is performed on the client. For example, collision detection processing may be performed for a given client for that local simulation, but the results of that processing may not be communicated back to the server (or may only be communicated in certain instances). In other words, when two objects are determined to collide on a client, the client determines how those two objects should react (e.g., by causing them to move based on the force of the collision). However, the results of that movement may not be communicated to the server (e.g., in cases that don't involve the player-controlled object 102 for the user associated with that client). Note that due to the differences in game state in each local simulation 702 (e.g., across the 50+ clients that are participating in a given game), there may be differences in how collisions are shown/determined for each respective client. For example, on a first client a collision between Scale and FuryBowser may be determined. But on a second client, no such collision may be determined at substantially the same point in the game. Alternatively, such a collision may be detected on the second client, but the collision processing on the second client may result in moving/updating the state data for Scale and/or FuryBowser differently than how the collision is handled on the first client.

Note that the same client-side collision processing/results may also not occur for clients processing data for an event object. For example, on one client an event object may collide with another object, but on a second client no such collision may be detected. Similarly, the results of a collision (if detected) may be different. Thus, the exact positioning of a given event object on a client may not be exactly replicated across all clients participating in the same game.

In some cases, the server may perform a different collision resolution process or may not perform any collision resolution process.

Turning now more specifically to FIG. 7, the server 502 executes a location simulation of the multiplayer game at 700 and each client 510 also executes a local simulation of the multiplayer game at 702. This may involve each respective computing device (the server and the client(s)) executing a game application that performs the operations in connection with running the simulation for the multiplayer video game. Further details of the processing performed in the simulation on a server are discussed in FIG. 8. Further details of the simulation performed on a client are discussed in FIG. 9.

In some examples, the execution of the server processing 700 is based on messages received from the clients and any local processing performed on the server for controlling non-player objects. As noted herein, non-player objects may include those that are based on previously recorded state data (e.g., event objects) and those that are not based on such data. As discussed herein, control and processing for event objects may also be based on the processing performed by dynamic module 507. Such control may be performed as part of the server processing 700 and/or may be performed as part of the processing 702 performed on local client(s) 510.

In some examples, execution of local simulations 702 on each client 510 may be based on messages received from the server (704), input 718 (e.g., via one input device(s) 1014) provided by user 716, and any local processing performed on the server 502 for controlling non-player objects (NPCs) within the race.

Messages (e.g., update messages) communicated from the server 502 to the client(s) 510 (at 704) and/or to the server 502 from client(s) 510 (at 706) may involve periodic updates (e.g., that occur once every X^{th} frame that the simulation has been updated, or other period) and/or updates that are triggered by an event or other triggering action. In some examples, messages are communicated from clients to the server every frame (e.g., each frame a client sends an update). In some examples, the server communicates updates to clients on a less frequent basis—e.g., once every other frame, once every 6^{th} frame, or the like. In some examples, significant event updates may be communicated from the server to clients when they are determined. An example of this may be when a vehicle activates a special ability or moves in a significant manner. Such updates may be sent in between the periodic updates communicated from/to the server.

Different types of data may be included in the messages communicated between the clients and server. The data that is communicated from a client to the server and then from the server to the client may involve any or all of the data shown in FIG. 6. In some examples, each update may include a timestamp (or other sequential value—e.g., from the start of the race) that is used to provide an indication to the client for when the data in the update should be reflected in the executing local simulation. In some examples, a value for a parameter may be transmitted, movement and/or position data (e.g., for a vehicle) may be transmitted, data regarding commands input by the user (e.g., the buttons are being or have been pressed), a status of the race (e.g., the ranking of players within the race) and other types of data, such as significant events that have occurred, and the like. In some instances, the data is periodically transmitted (e.g., every X^{th} frame, such as every other frame, every 10^{th} frame, or every 6^{th} frame, or at other rates such as every 1 ms, every 5 ms, 10 ms, or every 30 ms). In some instances, data messages are transmitted on an on-demand basis. For example, when a significant event occurs for vehicle 102 (e.g., the activation of a special power or the like), a data message regarding such a triggering may be transmitted.

Returning to FIG. 7, processing of the respective local 702 and server 700 simulations continues until the race is completed at 708. When the race is completed, then the server may update the player information of each player that participated in the race. For example, the experience or rating of the player may be updated based on their performance in the race. This updated data may be stored in the player database 608.

At 712, the results of the race are communicated to each of the client(s) 510. These results may then be displayed to the users on their respective computing devices at 714. The results may include the player who finished first in the race, a user's relative placement with respect to the event object (e.g., if the time for the user-controlled object was faster than the event object), and/or other information.

### Description of FIG. 8: Server Processing

FIG. 8 is a flow chart of a process that may be executed on a server computer system for the multiplayer video game shown in FIG. 1 according to certain example embodiments. The processing shown in FIG. 8 may be executed as part of (or be) the processing shown in FIG. 7 for the execution of the server processing 700. Once a new game instance has been created and the race has started, the processing shown in FIG. 8 may be performed. The processing shown in FIG. 8 may be performed at a rate of 24, 30, 60, or other rate per second (e.g., a tick rate at which the server runs).

At 800, updates that are sent from clients 510 are processed. The updates at 800 may include those periodic updates provided by clients 510 that include the movement information, user input device information and the like. These updates may be communicated by clients on a periodic basis to provide the server with updates to how the player-controlled object associated with that client is moving/performing within the game space.

At 804, any NPC processing is performed by the server 502. This may include determining whether to generate an NPC, the NPC should be located within the race, what action should be performed for the NPC, and the like. The NPC processing may also include loading or reading previously recorded state data at 802 from the recorded state database 509 and controlling an event object based on that read data. In some examples, the NPC processing 804 may include determining how the one or more NPCs or the like are to move or act within the game space and then communicating such information to the clients (e.g., at 814). In some examples, NPCs may also include computer controlled or AI (artificial intelligence) controlled objects (e.g., in contrast to human or player-controlled objects).

At 806, the simulation of the game that is maintained by the server computer system 502 is updated. More specifically, the server 502 maintains (similar to the clients) a game state that includes the position and other state data related to each of the vehicles/objects within the race. The processing performed at 806 may update this game state based on the data received from the clients (at 800) and updates to the NPCs performed at 804.

In some examples, the processing performed by the server and the processing performed by a client (or each client) may be different. In certain example embodiments, a difference between the processing performed in the multiplayer game on the clients and the server may be, for example, how collisions and other dynamic actions are handled.

In certain example embodiments, how event objects react to collisions is handled on each individual client without communicating the results of such collisions back to the server. Moreover, collisions may not be determined (and/or collision processing not performed) for event objects on the server (or may be handled differently than on the clients). Instead, the server may perform, at 808, (which may be part of the processing performed at 806), a determination as to whether a trigger condition for a dynamic action should be activated for an event object. Such processing may not be performed on the client. In other words, the determination of whether to dynamically trigger an action for an event object may be made by the server. Note that the server may then communicate the result of such determination—e.g., that an action for the event object is to be performed—to the client for processing.

In some examples, the processing at 808 may also include determining if a cooldown timer is active or not. If the cooldown timer is active, then no such triggering action will be activated, and the processing will continue to 814. In other words, if the cooldown timer is active, then the server-side processing may not need to calculate or determine whether a triggering action exists for the event object. If the cooldown timer is not currently active, and the triggering condition has been activated, then the processing moves to 810.

In some examples, a determination to trigger an action may be made even if the cooldown timer is active. For example, if the event object is determined to collide with a first type of object within the game, then the action may be triggered—even if the cooldown timer is still active. In some examples, the first type of object may be an AI controlled and/or NPC object (e.g., one that is not controlled based on input from a client). In some examples, the first type of object may be an object that explodes or results in damage when vehicles collide with it. This type of object may be an NPC object and controlled throughout the race to be, for example, a moving obstacle for players. For such objects, an additional check may be added to the collision processing such that if an event object is to collide with a first type of object (or if it is to get within a threshold distance), an action may be triggered—even if the cooldown timer is still active. The triggering of the action (e.g., as discussed below) may allow the event object to reduce or avoid the damage taken from the collision with this type of object. It will be appreciated that other object types and/or different types of effects may be provided within the game in accordance with certain example embodiments.

Next, at 810, an action for the event object is triggered. In some examples, the triggered action may be selected based on what triggering condition has been activated. In some examples, there may be only one triggering condition in the game. In such a case, there may be only one dynamic action to activate.

In certain example embodiments, the action that is triggered may be an action that does not substantially (or does not) change the speed and/or position of the event object within the race. However, it may affect the event object in other ways. For example, the action may cause the event object to take less damage, be invulnerable, or other change in state. An example of such an action is the spin move, or spin attack discussed herein.

Based on activation of the dynamic action, a cooldown timer may be activated at 812. In some examples, the cooldown timer is a predetermined amount of time (or a predetermined number of frames of execution). In other examples, the cooldown timer may be randomly determined, or may be randomly determined between a set minimum and a set maximum. In any event a cooldown timer may be activated and kept active until it expires. In some examples, the cooldown timer may reset (or add to its remaining duration) if the action has been triggered, but the cooldown timer is still active. This may occur, for example, if the event object is determined to collide (or will collide) with an object of the first type.

In some examples, the activation of the action at 810 may then be injected or added to processing performed on the server-side simulation (e.g., as part of 806). Subsequently, the results of such processing may be communicated to the clients at 814. In other examples, the triggering of the dynamic action may be communicated to the clients at 814. For example, an event to activate the triggered action for the event object may be communicated at 814 without first processing that action through the server-side simulation. Instead, the processing of the action may be communicated to each of the individual clients for processing therein.

The above techniques thus allow for previously recorded state data to be used to control an event object, but then also dynamically inject actions for the event object to take that are not based on (e.g., solely) the previously recorded state data. Instead, the state of the event object may be dynamically updated based on the current state of the race and/or objects within the current race. For example, if another object within the race is within a threshold distance of the event object.

Note that while collision processing is performed by clients (e.g., at 912 as discussed below), that such collision processing may not be similarly performed by the server 502 as part of the simulation maintained by the server. However, in certain examples, collision processing may also be performed by the server (e.g., to determine/modify the positional/movement data of the involved objects). In some examples collision processing may be performed if the objects do not involve an event object. Rather, potential collisions that involve an event object may be ignored or not processed by the server.

In some examples, collision processing may be performed by the server (e.g., at or in connection with 806) only based on the determination of one or more conditions. In illustrative example of such a condition is when a collision is determined to reduce the health of a vehicle involved in the collision to 0. This may be communicated to the server via a significant event update. The server may then determine whether the collision occurs or not.

At 814, the server generates and transmits any updates to the clients regarding the game state and/or the vehicles within the game. Such updates may include positional data, movement data, and health data for each vehicle within the race. The messages communicated to the clients will then be received by each client, which will then be incorporated into the client-side processing (e.g., as discussed in connection with FIG. 9). In some examples, the updates communicated at 814 may be sent to some fraction of the clients that are involved in the game. For example, if there are 60 participating clients, updates may be communicated to 10 clients during each frame of execution of the processing shown in FIG. 8. Thus, for example, each client may receive an update once every 6^{th} frame. Other frequencies of updating may be performed in some examples.

In some examples, the communication of updates to clients at 1008 may be split into different types of processing for providing updates. One update provided to clients may be based on the occurrence of “significant events” and another update may be based on the periodic updates. In some examples, only data regarding the significant event may be communicated (e.g., just that a specific vehicle has activated a special ability. In some examples, when a significant event occurs and then triggers such communication (whether from a client to the server, or from the server to the clients), the data communicated for the periodic updates may be included in such an update.

As with the client-side processing (e.g., FIG. 9), the processing shown in FIG. 8 may occur multiple times per second. The rate at which the processing is performed on the server 502 may be a “tick rate” or update rate or the like. This rate may correspond to the rate at which the server updates its own internal game state of the game that is being played. In some examples, this tick rate is the same or similar to that of the clients (e.g., 30 times per second), in other examples the tick rate may be faster (e.g., 100 times per second), and in other examples may be slower (e.g., 10 times per second).

### Description of FIG. 9: Client Processing

FIG. 9 is a flow chart of a process that may be executed on a computing device that is a client (such as shown in FIG. 5) in the multiplayer video game shown in FIG. 1 according to certain example embodiments.

Each client or each computing device that is being used by a user to participate in the multiplayer video may operate the process shown in FIG. 9. The process shown in FIG. 9 may be performed based on execution of computer instructions that are part of the game program 650 being executed by a corresponding computing device. And, as discussed in greater detail below, the processing shown in FIG. 9 can occur (and does occur in certain example embodiments) multiple times per second as data is received, processed, and then output. In some examples, the rate at which the looped process shown in FIG. 9 occurs is 24, 30, or 60 times per second. Other rates, whether fixed or variable, may also be implemented in certain example embodiments.

Once a race has started, then race processing 900 is performed.

At 902 user provided input is received and processed. This may include determining what buttons or other actions have been triggered by the user on an input device that is coupled to the computing device being used by the user. For example, if there are 5 different buttons on an input device, the computing device may store the status of each of these buttons (or just which ones are pressed). As an illustrative example, each button may be represented by a state variable (e.g., a state of the corresponding input) that is used to track if a button is pressed, how much is it pressed, or the like.

Different types of input may be processed according to certain example embodiments. For example, the input may be voice commands and accordingly the processing at 902 may include determining what voice command has been provided. In certain examples, historical data that a user has input is stored into a data structure or input buffer. In other examples, the input that is provided need not be stored past its use in the current frame of execution.

One type of input that may be provided at 902 is a trigger for the special ability that is associated with the special ability meter 114. If the input associated with the special ability is provided, then the process may determine if the value tracked in connection with the special ability meter 114 meets or exceeds a given threshold at 920. If so, then the special ability is activated (note that there may be additional conditions for activation in certain example embodiments). Additionally details of the special ability processing in connection with transitioning to a second track within the race are described in more detail in FIG. 11.

In certain example embodiment, triggering the second track at 920 may occur automatically once the special ability is full or has reached a threshold. In certain example embodiments, automatic triggering of the special ability may be based on other conditions within the game. For example, if the player is to crash out (e.g., health reduced to zero) and the special ability meter is full, then the game may automatically trigger the special ability to warp the vehicle to the second track. Other types of triggering conditions (e.g., speed, place in the race, etc.) may be used to control our automatically trigger the special ability in certain example embodiments.

At 904, one or more data messages (e.g., packets) may be received from the server system 602. Data transmitted from the server system 602 may include data regarding parameters or attributes of vehicles other than that controlled by the user of the current client (e.g., other than vehicle 102). Such attributes may include the health of the other vehicles (e.g., as represented via bar 112), movement data of the other vehicles (such as velocity as represented by the km/h shown in FIG. 1), whether a collision between the vehicle 102 and another vehicle has occurred, direction data of the other vehicles, and the like.

In some examples, collision events are only transmitted if the collision between vehicle 102 and the other vehicle would cause the health of either vehicle to drop to 0 (or just the health of the vehicle 102 of the current user). In some examples, when a vehicle causes a collision that reduces the health of another to 0 (to knock them out of the race), then the health of the remaining vehicle may be increased.

At 906, data (e.g., packets) may be sent to the server 602 for processing. The data communicated from a given client to the server may be the same or similar to that received by the server 602. However, in certain examples, the data communicated to the server 602 may only relate to the attributes or properties of the vehicle 102. In other words, data regarding the state of the other player vehicles for a given local simulation may not be transmitted from the client of vehicle 102. Rather, data for such vehicles may only be received from the server 602. Indeed, in certain examples, messages that are communicated to the server from a given client may only relate to properties of the vehicle 102 for that client.

In some examples, the state data of the input device that is used by the user may be sent. This state data may include the current state of the controller/user input device (e.g., what buttons or the like that are being pressed or used). In some examples, the data may be communicated to the server after the game state is updated for each frame (after 910). In other words, the inputs provided by the user using the user input device may be applied to update or modify any parameters of the vehicle 102 being controlled by the user and the result of that processing may be communicated to the server 602.

In some examples, when vehicle 102 is involved in a collision and that vehicle is the “attacker”, then an attacker priority flag may be included in the message communicated to the server. This may be used by the server 602 to resolve collisions in favor of the “attacker.”

At 908, processing for controlling any non-player-controlled objects of the video game may be performed. As an illustrative example, a non-player vehicle may be present on the track and may be designed to drop energy objects periodically. The processing at 906 may control the speed, direction (or existence of) such non-player vehicle. Further, and as discussed elsewhere herein, the generation of energy objects by such non-player vehicles may also be triggered. In some examples, data received from the server 602 may be used to control the non-player vehicle at 906. As one illustrative example, the non-player object that is used to drop energy objects may be triggered by an instruction from the server 602. However, the movements of that vehicle may be controlled via the local simulation (e.g., instructions on how to move the non-player vehicle may not be provided by the server 602).

In certain example embodiments, the processing for NPCs may vary between the various clients that are participating in the same multiplayer game. As an example, the “same” NPC may be present within each locally executing simulation of the multiplayer game that is being executed on each client. The existence of such an NPC in the game may be controlled based on, for example, an instruction to display/spawn that NPC that is received from the server 602. Accordingly, in certain examples, the position of the NPC may be the same across various clients. However, in other examples, the location of the NPC on each client may be independently handled. The NPC may be designed to drop energy objects on the racetrack. However, the rate at which energy objects are dropped (or how many are dropped) may vary for each client. In certain example embodiments, the distribution of energy objects from such NPCs for each client may be a function of (e.g., based on), the placement of where the vehicle 102 for that client is within the race. Thus, for example, if a player-controlled object is in first place, then the rate at which energy objects are dropped by that NPC in the local simulation for the client of that player-controlled object may be 1 per 5 seconds. In contrast, the same NPC that is being simulated on another client for another player-controlled object that is in 50^{th} place may have a drop rate for energy objects of 1 per second. Accordingly, the drop rate of energy objects by NPCs within the local simulation that is being performed (e.g., at 802) may be controlled based on where the corresponding player-controlled-object is placed within the race for the multiplayer game. In certain examples, the higher the current placement for a vehicle, the lower the drop rate within the local simulation of that vehicle.

Other types of varied NPC control may also be provided in certain examples. For example, an NPC may be generated within each local simulation and be designed to interfere with the control of the player-controlled object (e.g., by attempting to collide with the player-controlled object or the like). The aggressiveness with which this NPC seeks to accomplish this task may be a function of the current rank of the player-controlled object. Other aspects that may be controlled entirely (or mostly) within the local simulation are discussed below in connection with 924, 926, and elsewhere herein.

In some examples, other vehicles that are participating in the race may be NPC controlled. How these vehicles are controlled may be provided/determined by the server. In other words, instead of receiving position/state updates from clients and then the server communicating those updates to clients, the server itself will generate position/state data for those NPC participating vehicles, and then communicate such data to the clients.

Returning more specifically to FIG. 9, once the data regarding input from the player is processed (at 902), and any current updates are received/processed from the server (at 904), and the processing for updating any NPC objects is performed (at 908), then the game state of the local simulation is updated at 910. The updating of the game state may include updating the positions of the player's vehicle 102 and other objects within the virtual game space based on the newly received input/messages (from 902/904/908).

In some examples, the updating of the positions of the objects may include calculating the position at which those objects are to be located by performing an interpolation based on the data that has been received (or not received). For example, the position of an object may be 2, 2, but the newest state data received from the server may indicate that the position of that object is 10, 10. In such a case, the client-side processing may perform an interpolation to adjust the position of the object to be, for example, at position 4, 4). While this is not the “true” position reported from the server to the client, using interpolation can result in a smoother gameplay experience for the user of that particular client as the object would not suddenly “warp” from 2, 2, to 10, 10.

Note that interpolation may be used to slowly correct the position and/or other state data of an object that has been changed on a client but has not similarly been changed in the server-side simulation. An example of this is collision processing that may be performed for event objects on the clients, but not performed on the server. For example, using the above positional example of interpolation, the server may report that an event object is at 5, 5 for one frame, but then 10, 10 for the next. However, one or more clients may have a collision caused that changes the position of the event object from 5, 5 to be at 2, 2 (e.g., another object rammed/collided with the event object). In such a scenario, the client-side interpolation may continue to update the event object using other state data (e.g., based on the speed, the movement angle, etc.). However, when a new update is received from the server that indicates the event object is now at position 10, 10, the client will perform additional interpolation using the newly received data. Note that the client may not simply update the position of the event object to 10, 10. Instead, the client-side interpolation may use the state data sent by the server (e.g., including controller inputs, etc.) to correct the present data of the event object over one (or a plurality of frames). This may be based on timestamps and other time related aspects for the newly received data so as to gradually move the position (and/or other state data) of the event object on the client to match (or towards) the state of the event object on the server.

In some examples, different types of interpolation algorithms may be used depending on the nature of the objects in the game. For example, a first type of interpolation may be used for player objects, a second type for AI controlled objects (e.g., other than event objects), and a third type for event objects. In certain example embodiments, event objects may use a different interpolation algorithm (or the same algorithm with different values). In some examples, a difference may be that event objects are interpolated more slowly than other objects. Thus, for example, if a current and past position for an object indicates a distance of 4, then interpolation for a non-event object may move the object % h of the way to the current position. However, interpolation for an event object may only move it ½ of the way to the current position. In some examples, all of the objects in the game (e.g., player objects, NPC objects, event objects, etc.) may use the same interpolation algorithm to handle how the state of a given object should be updated.

In other instances, new data regarding the other player vehicles (or other aspects of the game) may not be received from the server for every frame of execution (e.g., because the server may only send updates every 3^{rd} or 6^{th} frame or the like for an object). Thus, interpolation may also be used to guess where other player vehicles will be located for this frame and what actions they may take. Such interpolation may also be beneficial due to the latency of communicating the actions of one vehicle from a first computing device, via the server, to another computing device. The delay may be 100 ms or more between the two computing devices. Accordingly, in certain examples, the data received from the server may be processed using an interpolation algorithm or the like in order to provide a better “guess” as to where the vehicles of the other objects are located within the virtual game space.

In any event, the local game state of the locally executing instance of the game program 550 is updated in order to, for example, update the positions (and/or other state data) of the vehicles and other objects within the virtual game space.

With the positions of the objects within the virtual game space updated, then at 912, collision detection processing may be performed at 914. This may involve determining when two (or more) vehicles (or other objects) have collided with each other within the game world. Such processing may include determining if some (or all) of two or more vehicles occupy the same location within the virtual game space.

An illustrative example of a collision occurring is shown in FIG. 3 when vehicles 140 and 110 collide with one another (with the aftermath of the collision shown in FIG. 4). This collision may be determined due to updates received from the server 502 (or based on interpolation). Once the movement related data for vehicles 140 and 110 is received from the server (e.g., at the computing device being operated by the user controlling vehicle 102)—or interpolation has been performed, the game state the local simulation of the video game may be updated from what is shown in FIG. 2 to what is shown in FIG. 3 (e.g., additional frames may have been displayed in the interim) in a manner that causes the collision between the two vehicles. Once a collision is detected, then the additional processing may be triggered. For example, the force of the collision may cause a change in speed or position of the involved objects.

In some examples, the collision detection processing may also include determining and handling collisions that occur with other objects or elements within the race. For example, when a vehicle collides with a barrier or the like.

In some examples, when collisions are detected between two other player vehicles (including the event object), the local simulation may handle such collisions internally. However, if a collision involves the player-controlled object 102, then the tracked health (as shown in 112 of FIG. 1) may be decreased due to the collision. Additionally, the health of the vehicle 102 may be communicated to the server for handling.

In contrast, the health of the other player vehicles may not be communicated to the server from another client. More specifically, in some examples, collisions that occur between other player vehicles may not affect the tracked health of those vehicles within that simulation. Rather, the health values may be updated and controlled based on messages received from server 502. In other words, health updates for vehicle 102 may be controlled based on the corresponding “local” simulation for that vehicle, while the health of other vehicles (e.g., 106/108/110 and/or 140) may be based on the health parameter for a vehicle received at 904 from the server (e.g., that is part of the state data communicated from the server to each client).

In some examples, collision detection processing for event objects may be handled by clients. Such collision processing may be performed instead of processing performed on the server or may be performed in addition to such processing performed on the server. As an illustrative example, collision processing may be performed that determines if an event object is to collide (e.g., if the event object comes within a threshold distance) with a first type of object (e.g., an AI controlled object). When such a collision occurs, the event object may be dynamically caused to perform the action (e.g., that can also be triggered from 810). Note that when the server processing determines that the action should be triggered for the event object, the updated state data for the event object may then be communicated to all clients to perform that action. However, due to variations in how each client is simulating the race, the performance of that action may not exactly be handled the same for each client. In other words, on a first client the triggered action for the event object may be shown to occur at position 2, 2. And on a second client the same triggered action may be shown to occur at position 2, 3. For any, all, or none of the clients, the action may be shown being performed when the event object collides with an object or not. In other words, even if the local client-side simulation does not show a collision, the triggered action may still be performed for the event object because the server has instructed that such an action be performed for the event object.

In other examples, collisions processing for event objects may be performed on the client. For example, if an event object is determined to collide with a first type of object (e.g., that explodes on collision), then the client-side processing may automatically cause the event object to perform an action (e.g., a spin move) that allows the event object to not be affected (or not affected as much) by colliding with the first type of object.

In some examples, state data that indicates that the event object is to perform a spin move due to collision with a first type of object may be communicated to the client. Each client may then determine (as part of the client-side processing) when to render/cause the “spin move” for the event object to take place. For example, one client may determine that a collision occurs at timestamp 50. And another at time stamp 55. The determination may be based on, for example, when the client determines that a collision has occurred. Note, however, that if the server does not communicate to the client that a spin move should occur, then no spin move may be triggered. Thus, the dynamic triggering of actions may be controlled by the server, but clients may have some variation for when such actions should be caused to occur.

In some examples, the processing performed by a client may be based on the latency from the individual client to the server. If the latency value is above a threshold, then the local simulation may be used to determine whether a triggering condition exists as reflected in the local game state. This may occur because, for example, the updates from the server are being received too far in the “past” (e.g., the latency may be 500 ms or more, 1 second or more, or greater, etc.). Accordingly, the client-side simulation may take over any or all of the responsibilities of determining whether to trigger an action for the event object in response to determination that a network connection to the server is not providing a sufficient level of gameplay for the user. When this occurs, the client-side simulation may take over (e.g., as backup or the like) and perform a determination may be the same or similar to that performed at 808 by the server. If the condition exists in the client-side game state, then the dynamic action may be performed for the event object. In certain example embodiments, the client simulation may include its own cooldown timer (similar to that maintained by the server). In other examples, no such cooldown timer may be used as part of the client-side simulation (e.g., unlike the server-side simulation). As network latency can change, circumstances may change such that the server provides an update (which arrives more quickly). The update may include state data that the event object is to perform a dynamic action. The client may perform this action even if a cooldown timer maintained by the client is still active. In other examples, the presence of the client-maintained cooldown timer may suppress the activation of the dynamic action for that client.

In some examples, the enabling of client-side control of the event object may be turned on/off based on a measured latency value—and this change may occur more than once over the course of a single race. Accordingly, different techniques for handling collisions, dynamic action triggering, and/or determination of triggering conditions may be performed according to various different embodiments.

In some examples, the transmission of data to the server regarding the attributes of vehicle 102 (e.g., 906) may occur after the updating of the game state or after the collision detection processing.

In some examples, the transmission of data to the server system 502 may not occur in every frame, but may instead occur, for example, every other frame or every 5^{th} or 6^{th} frame, or other interval.

Once the game state of the game space has been updated for the current frame (which may include performance of collision detection at 914), then a view of the game space is rendered at 916. As shown in FIG. 1-4, the view that is generated may be a “third” person perspective that includes the vehicle 102 being controlled by the user. It will be appreciated that other types of view (e.g., first person or the like) may be generated in certain example embodiments. In some examples, the rendering may include generating the heads-up display elements and overlaying those on the rendering image.

Once the image is generated, then it is output to a display device that is coupled to the computing device at 918 for viewing by the user that is playing the multiplayer video game.

Steps 902 through 918 may be referred to as race processing 900. These steps may be used to process new data, update the game state of the race of the locally executing simulation, and present a result to a user (e.g., in the form of an image, audio, or the like). In some examples, each of the elements shown in FIG. 9 may be performed as part of the race processing.

In certain examples, the processing shown in FIG. 9 operates multiple times per second in order to output images at a sufficient frame rate. Illustrative frame rates may be 24, 30, 60 or more frames (e.g., images) per second. It will be appreciated that not every element shown as part of race processing may be performed for each iteration. For example, new data from the server 502 may not (and likely will not) be received every frame of execution. This may be due to latency or the rate at which the server 502 communicates updates to the clients. Similarly, data may not be transmitted to the server 502 for every iteration. If there are no NPCs present in the race, then there may be no NPC processing.

### Additional Example Embodiments

In certain example embodiments, additional actions that may be triggered may be reaction events that may include emotes, textual, or audio reactions by the event objects. For example, if the event object 140 is passed by the player object 102 (or another object), then the event object may be caused to react with a voice line or an emote. In another example, if a spin attack is performed by the event object is successful (e.g., in knocking out a player), if the event object is hit by a spin attack performed by the player, etc. Then the event object may be triggered to perform an appropriate reaction event.

In certain example embodiments, another triggering action may be a determination that the event object will likely (or will) hit another object. For example, in some cases, an object may be an AI controlled object (e.g., not being controlled by a player). In such an example, the server may cause the event object to try and steer around that object (e.g., as part of the server-side processing). In other examples, the server may dynamically steer the AI object so as to avoid where the event object is heading within the game. In other words, the event object may maintain its preset course without any (or substantial) modification to the course determined by the previously recorded event data. However, the server may control any AI objects to avoid the event object. On the client side, similar actions may be performed (or at least communicated to the client). Further, if a collision does occur, then interpolation techniques may be used to guide the event object back to the course dictated by the server.

In certain example embodiments, if an event object falls further behind the state of the record state data, then a turbo speed boost may be applied to the event object as part of the client-side processing. This may be used to allow the event object on the client to “catchup” to the event object at the server (e.g., a similar speed boost would not be performed on the server).

In certain example embodiments, which triggering condition and/or actions may be based on a selected game type. For example, a first condition is associated with a first game type. And second and third conditions are associated with a second game type. And the first condition and a fourth condition may be associated with a third game type. The game types may each have their own triggering actions as well.

In certain example embodiments, a super turbo ability and/or the ability to transport to a secondary track (such as discussed in U.S. Ser. No. 18/461,061, the entire contents of which being hereby incorporated by reference) may be dynamically triggered. In such instances, the reliance on the recorded state data may be suspended while the ability is active. When the ability ends, the reliance on the previously recorded state data may be resumed. Note which instance of previously recorded state data is used may be offset by based on the activation. For example, when the ability stops, the state data with position information that is nearest to the current location of the event object may be used and a timer offset may be used to subsequently appropriate load the next state data instance. Thus, the event object may “fast forward” or the like and then have the reliance on the recorded state data resumed (e.g., at a landing point or exit point for the previously activated special ability). Thus, in some examples, the server may rely upon or use the previously recorded state data (e.g., some parts of a race). During other time periods of the race, the previously recorded state data may not be relied upon, and, for example, real-time AI control may be used for the event object.

In some examples, the playback speed for the event data may be adjusted based on the current position of the event object within the race. If the event object is leading, then the playback speed may be slowed down. If the event object is trailing (perhaps in the middle of all players), then the replay speed of the event object may be increased. In some examples, the playback speed may be adjusted depending on the difficulty that is assigned to the event object.

In some examples, an event object may use or rely upon a combination of prior recording. The data for such recordings may be, for example, spliced together, based on, for example, the overall state of a race. In some examples, the state data for a prior recording may be based on where the event object started the race. In other words, each object may start at a different location (e.g., when there are 100 objects racing, they may be spread out by quite a distance).

In certain example embodiments, the splicing of different recordings may be based on, for example, a result of a first lap around a track, then a different recording for the second lap. In some examples (e.g., if a race has 5 laps), 5 different recordings may be initially selected and then each recording is used for 1 lap of the race. In some examples, a new recording may be selected for each lap and in other examples the previously recorded state data that is used may be based on a result of a given lap (e.g., if the event object is in one of places 1-4 use recording A. If the event object is at positions 5-10 use recording B, if in the bottom half use recording D, etc.

### Description of FIG. 10

FIG. 10 is a block diagram of an example computing device 1000 (which may also be referred to, for example, as a “computing device,” “computer system,” or “computing system”) according to some embodiments. In some embodiments, the computing device 1000 includes one or more of the following: one or more processors 1002 (which may be referred to as “hardware processors” or individually as a “hardware processor”); one or more memory devices 1004; one or more network interface devices 1006; one or more display interfaces 1008; and one or more user input adapters 1010. Additionally, in some embodiments, the computing device 1000 is connected to or includes a display device 1012. As will explained below, these elements (e.g., the processors 1002, memory devices 1004, network interface devices 1006, display interfaces 1008, user input adapters 1010, display device 1012) are hardware devices (for example, electronic circuits or combinations of circuits) that are configured to perform various different functions for the computing device 1000. In some embodiments, these components of the computing device 1000 may be collectively referred to as computing resources (e.g., resources that are used to carry out execution of instructions and include the processors (one or more processors 1002), storage (one or more memory devices 1004), and I/O (network interface devices 1006, one or more display interfaces 1008, and one or more user input adapters 1010). In some instances, the term processing resources may be used interchangeably with the term computing resources. In some embodiments, multiple instances of computing device 1000 may be arranged into a distributed computing system.

In some embodiments, each or any of the processors 1002 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1002 uses an instruction set architecture such as x86 or Advanced RISC Machine (ARM). In some embodiments, each or any of the processors 1002 is or includes, for example, a graphical processing unit (GPU), which may be an electronic circuit designed to generate images and the like. One or more of the processors 1002 may be referred to as a processing system in certain examples.

In some embodiments, each or any of the memory devices 1004 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1002). Memory devices 1004 are an example of non-transitory computer-readable storage.

In some embodiments, each or any of the network interface devices 1006 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), LTE Pro, Fifth Generation New Radio (5G NR) and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, data is communicated over an electronic data network. An electronic data network includes implementations where data is communicated from one computer process space to computer process space and thus may include, for example, inter-process communication, pipes, sockets, and communication that occurs via direct cable, cross-connect cables, fiber channel, wired and wireless networks, and the like. In certain examples, network interface devices 1006 may include ports or other connections that enable such connections to be made and communicate data electronically among the various components of a distributed computing system.

In some embodiments, each or any of the display interfaces 1008 is or includes one or more circuits that receive data from the processors 1002, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 1012, which displays the image data. Alternatively, or additionally, in some embodiments, each or any of the display interfaces 1008 is or includes, for example, a video card, video adapter, or graphics processing unit (GPU). In other words, the each or any of the display interfaces 1008 may include a processor therein that is used to generate image data. The generation or such images may occur in conjunction with processing performed by one or more of the processors 1002.

In some embodiments, each or any of the user input adapters 1010 is or includes one or more circuits that receive and process user input data from one or more user input devices (1014) that are included in, attached to, or otherwise in communication with the computing device 1000, and that output data based on the received input data to the processors 1002. Alternatively, or additionally, in some embodiments each or any of the user input adapters 1010 is or includes, for example, a PS/2 interface, a USB interface, a touchscreen controller, or the like; and/or the user input adapters 1010 facilitates input from user input devices 1014.

In some embodiments, the display device 1012 may be a Liquid Crystal Display (LCD) display, Light Emitting Diode (LED) display, or other type of display device. In embodiments where the display device 1012 is a component of the computing device 1000 (e.g., the computing device and the display device are included in a unified housing), the display device 1012 may be a touchscreen display or non-touchscreen display. In embodiments where the display device 1012 is connected to the computing device 1000 (e.g., is external to the computing device 1000 and communicates with the computing device 1000 via a wire and/or via wireless communication technology), the display device 1012 is, for example, an external monitor, projector, television, display screen, etc.

In some embodiments, each or any of the input devices 1014 is or includes machinery and/or electronics that generates a signal that is provided to the user input adapter(s) 1010 in response to physical phenomenon. Examples of input devices 1014 include, for example, a keyboard, a mouse, a trackpad, a touchscreen, a button, a joystick, a sensor (e.g., an acceleration sensor, a gyro sensor, a temperature sensor, and the like). In some examples, one or more input devices 1014 generate signals that are provided in response to a user providing an input—for example, by pressing a button or actuating a joystick. In other examples, one or more input devices generate signals based on sensed physical quantities (e.g., such as force, temperature, etc.). In some embodiments, each or any of the input devices 1014 is a component of the computing device (for example, a button is provided on a housing that includes the processors 1002, memory devices 1004, network interface devices 1006, display interfaces 1008, user input adapters 1010, and the like).

In some embodiments, each or any of the external device(s) 1016 includes further computing devices (e.g., other instances of computing device 1000) that communicate with computing device 1000. Examples may include a server computer, a client computer system, a mobile computing device, a cloud-based computer system, a computing node, an Internet of Things (IoT) device, etc. that all may communicate with computing device 1000. In general, external devices(s) 1016 may include devices that communicate (e.g., electronically) with computing device 1000. As an example, computing device 1000 may be a game device that communicates over the Internet with a server computer system that is an example of external device 1016. Conversely, computing device 1000 may be a server computer system that communicates with a game device, which is an example of external device 1016.

In various embodiments, the computing device 1000 includes one, or two, or three, four, or more of each or any of the above-mentioned elements (e.g., the processors 1002, memory devices 1004, network interface devices 1006, display interfaces 1008, and user input adapters 1010). Alternatively, or additionally, in some embodiments, the computing device 1000 includes one or more of: a processing system that includes the processors 1002; a memory or storage system that includes the memory devices 1004; and a network interface system that includes the network interface devices 1006. Alternatively, or additionally, in some embodiments, the computing device 1000 includes a system-on-a-chip (SoC) or multiple SoCs, and each or any of the above-mentioned elements (or various combinations or subsets thereof) is included in the single SoC or distributed across the multiple SoCs in various combinations. For example, the single SoC (or the multiple SoCs) may include the processors 1002 and the network interface devices 1006; or the single SoC (or the multiple SoCs) may include the processors 1002, the network interface devices 1006, and the memory devices 1004; etc.

The computing device 1000 may be arranged in some embodiments such that: the processors 1002 include a multi or single-core processor; the network interface devices 1006 include a first network interface device (which implements, for example, WiFi, Bluetooth, NFC, etc.) and a second network interface device that implements one or more cellular communication technologies (e.g., 3G, 4G LTE, CDMA, etc.); the memory devices 1004 include RAM, flash memory, or a hard disk. As another example, the computing device 1000 may be arranged such that: the processors 1002 include two, three, four, five, or more multi-core processors; the network interface devices 1006 include a first network interface device that implements Ethernet and a second network interface device that implements WiFi and/or Bluetooth; and the memory devices 1004 include a RAM and a flash memory or hard disk.

The hardware configurations shown in FIG. 10 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 10, (e) via other hardware arrangements, architectures, and configurations, and/or via combinations of the technology described in (a) through (e).

### Technical Advantages of Described Subject Matter

In certain example embodiments, techniques for implementing multiplayer video games that have, for example, a large number of users are provided. The techniques include processing certain types of interactions for the multiplayer game entirely (or mostly) within a local simulation of a given client. These individual simulations may be different even though each client is part of the “same” multiplayer game. This approach advantageously allows for not having to completely synchronize every aspect of the multiplayer game across the tens or even hundreds of different simulations that are being executed across the various clients that are participating in the same game. The technical advantage of this approach advantageously provides for not transmitting data regarding certain events—while still providing concurrent gameplay across the various clients of the multiplayer video game.

In certain example embodiments, techniques for implementing dynamic interactions in combination with previously recorded state data in a multiplayer video game are provided. The techniques include controlling the state of event object(s) on a server, but allowing different processing (e.g., based on collisions, etc.) to be locally performed on client systems for those same event objects. The local processing can allow for a more dynamic interaction with the previously recorded state data. The dynamic interaction is also facilitated by determining when a triggering condition is satisfied and then triggering a dynamic action for an event object. In certain example embodiments, the triggering may be additionally controlled based on a cooldown timer that is maintained by the server.

In certain example embodiments, the same action for a given object (e.g., an event object) may be triggered in multiple different ways. A first occurrence may be if previously recorded state data causes the action to occur. A second occurrence may be determination as to whether one or more triggering conditions exist (e.g., based on the dynamic nature of the current state of a virtual game space). The occurrence of the first and second option may be additionally dependent on a cooldown timer not being active. A third occurrence may also trigger the same action. However, the third occurrence may not be dependent on whether or not the cooldown timer is active (and may generally occur less frequently than the second action). In other words, with the third option, the action may always be triggered (e.g., force triggered) in contrast to the other two instances in which that same action may be triggered.

### Selected Terminology

The elements described in this document include actions, features, components, items, attributes, and other terms. Whenever it is described in this document that a given element is present in “some embodiments.” “various embodiments,” “certain embodiments,” “certain example embodiments, “some example embodiments,” “an exemplary embodiment,” “an example,” “an instance,” “an example instance,” or whenever any other similar language is used, it should be understood that the given element is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments.

Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an”, and “the” should be read as meaning “at least one,” “one or more,” or the like; the term “example”, which may be used interchangeably with the term embodiment, is used to provide examples of the subject matter under discussion, not an exhaustive or limiting list thereof; the terms “comprise” and “include” (and other conjugations and other variations thereof) specify the presence of the associated listed elements but do not preclude the presence or addition of one or more other elements; and if an element is described as “optional,” such description should not be understood to indicate that other elements, not so described, are required.

As used herein, the term “non-transitory computer-readable storage medium” includes a register, a cache memory, a ROM, a semiconductor memory device (such as D-RAM, S-RAM, or other RAM), a magnetic medium such as a flash memory, a hard disk, a magneto-optical medium, an optical medium such as a CD-ROM, a DVD, or Blu-Ray Disc, or other types of volatile or non-volatile storage devices for non-transitory electronic data storage. The term “non-transitory computer-readable storage medium” does not include a transitory, propagating electromagnetic signal.

The claims are not intended to invoke means-plus-function construction/interpretation unless they expressly use the phrase “means for” or “step for.” Claim elements intended to be construed/interpreted as means-plus-function language, if any, will expressly manifest that intention by reciting the phrase “means for” or “step for”; the foregoing applies to claim elements in all types of claims (method claims, apparatus claims, or claims of other types) and, for the avoidance of doubt, also applies to claim elements that are nested within method claims. Consistent with the preceding sentence, no claim element (in any claim of any type) should be construed/interpreted using means plus function construction/interpretation unless the claim element is expressly recited using the phrase “means for” or “step for.”

Whenever it is stated herein that a hardware element (e.g., a processor, a network interface, a display interface, a user input adapter, a memory device, or other hardware element), or combination of hardware elements, is “configured to” perform some action, it should be understood that such language specifies a physical state of configuration of the hardware element(s) and not mere intended use or capability of the hardware element(s). The physical state of configuration of the hardware elements(s) fundamentally ties the action(s) recited following the “configured to” phrase to the physical characteristics of the hardware element(s) recited before the “configured to” phrase. In some embodiments, the physical state of configuration of the hardware elements may be realized as an application specific integrated circuit (ASIC) that includes one or more electronic circuits arranged to perform the action, or a field programmable gate array (FPGA) that includes programmable electronic logic circuits that are arranged in series or parallel to perform the action in accordance with one or more instructions (e.g., via a configuration file for the FPGA). In some embodiments, the physical state of configuration of the hardware element may be specified through storing (e.g., in a memory device) program code (e.g., instructions in the form of firmware, software, etc.) that, when executed by a hardware processor, causes the hardware elements (e.g., by configuration of registers, memory, etc.) to perform the actions in accordance with the program code.

A hardware element (or elements) can be understood to be configured to perform an action even when the specified hardware element(s) is/are not currently performing the action or is not operational (e.g., is not on, powered, being used, or the like). Consistent with the preceding, the phrase “configured to” in claims should not be construed/interpreted, in any claim type (method claims, apparatus claims, or claims of other types), as being a means plus function; this includes claim elements (such as hardware elements) that are nested in method claims.

### Additional Applications of Described Subject Matter

Although process steps, algorithms or the like, including without limitation with reference to FIGS. 7-9, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A non-transitory computer readable storage medium storing computer executable instructions for use with a computer system that includes at least one hardware processor, the stored computer executable instructions comprising instructions that are configured to cause the computer system to perform operations comprising:
storing previously recorded state data that includes multiple types of state data for recreating states of at least one object in another instance of a multiplayer video game;
executing a simulation process that includes processing a plurality of virtual objects in a virtual game space, the plurality of virtual objects including a plurality of participant controlled virtual objects and at least one second virtual object;
receiving update messages from a plurality client computing systems that are each associated with a respective one of the plurality of participant controlled virtual objects;
as part of executing the simulation process, controlling movement of the second virtual object through the virtual game space based on the stored previously recorded state data;
based on a current state of the virtual game space, determining that a triggering condition has been satisfied for the second virtual object;
based on determination that a triggering condition is satisfied, triggering a dynamic action for the at least one second virtual object to be performed; and
transmitting, to each of the plurality client computing systems, an update message that is based on the dynamic action being triggered.

2. The non-transitory computer readable storage medium of claim 1, the operations further comprising:
based on triggering of the dynamic action, activating a timer for a duration,
wherein determination that the triggering condition has been satisfied is also based on whether the timer is active.

3. The non-transitory computer readable storage medium of claim 2, wherein the previously recorded state data includes a state that corresponds to performance of an action that is the same as the dynamic action, the operations further comprising:
triggering, based on the previously recorded state data, the second virtual object to perform the action that is the same as the dynamic action.

4. The non-transitory computer readable storage medium of claim 3, wherein the operations further comprise:
based on triggering of the action that is the same as the dynamic action via the previously recorded state data, activating the timer for a duration.

5. The non-transitory computer readable storage medium of claim 2, wherein the previously recorded state data includes a second state that corresponds to another performance of the action that is the same as the dynamic action, the operations further comprising:
determining that the timer is active and based on the determination that the timer is active, controlling the second virtual object without triggering another instance of the action that is the same as the dynamic action for the other performance of the action.

6. The non-transitory computer readable storage medium of claim 2, wherein the operations further comprise:
based on a current state of the virtual game space, determining that another triggering condition has been satisfied for the second virtual object, wherein the timer is active when the other triggering condition is determined to have been satisfied; and
based on determination that the other triggering condition is satisfied, triggering the dynamic action for the at least one second virtual object to be performed.

7. The non-transitory computer readable storage medium of claim 1, wherein the triggering condition is based on determination that the second virtual object has or will collide with another one of the plurality of virtual objects.

8. The non-transitory computer readable storage medium of claim 1, wherein the update message includes an instruction to perform the dynamic action.

9. The non-transitory computer readable storage medium of claim 1, wherein the recorded state data includes a timestamp value, positional data, orientation data, movement vector data, controller status data.

10. The non-transitory computer readable storage medium of claim 1, wherein each of the plurality client computing systems execute a client-side simulation multiplayer video game that is based on reception and subsequent processing of the update message.

11. A computing system for executing a multiplayer video game with a plurality of client game devices, the computing system comprising:
at least one hardware processor that is coupled to memory, the at least one hardware processor configured to perform operations comprising:
storing previously recorded state data that includes multiple types of state data for recreating states for an object;
executing a simulation process that includes a plurality of virtual objects in a virtual game space, the plurality of virtual objects including a plurality of participant controlled virtual objects and at least one second virtual object;
receiving update messages from a plurality client computing systems that are each associated with a respective one of the plurality of participant controlled virtual objects;
as part of executing the simulation process, controlling movement of the second virtual object through the virtual game space based on the stored previously recorded state data;
based on a current state of the virtual game space, determining that a triggering condition has been satisfied for the second virtual object;
based on determination that a triggering condition is satisfied, triggering a dynamic action for the at least one second virtual object to be performed; and
transmitting, to each of the plurality client computing systems, an update message that is based on the dynamic action being triggered.

12. The computing system of claim 11, wherein the operations further comprise:
based on triggering of the dynamic action, activating a timer for a duration,
wherein determination that the triggering condition has been satisfied is also based on whether the timer is active.

13. The computing system of claim 12, wherein the previously recorded state data includes a state that corresponds to performance of an action that is the same as the dynamic action, wherein the operations further comprise:
triggering, based on the previously recorded state data, the second virtual object to perform the action that is the same as the dynamic action.

14. The computing system of claim 13, wherein the operations further comprise:
based on triggering of the action that is the same as the dynamic action via the previously recorded state data, activating the timer for a duration.

15. The computing system of claim 12, wherein the previously recorded state data includes a second state that corresponds to another performance of the action that is the same as the dynamic action, wherein the operations further comprise:
determining that the timer is active and based on the determination that the timer is active, controlling the second virtual object without triggering another instance of the action that is the same as the dynamic action for the other performance of the action.

16. The computing system of claim 12, wherein the operations further comprise:
based on a current state of the virtual game space, determining that another triggering condition has been satisfied for the second virtual object, wherein the timer is active when the other triggering condition is determined to have been satisfied; and
based on determination that the other triggering condition is satisfied, triggering the dynamic action for the at least one second virtual object to be performed.

17. The computing system of claim 11, wherein the triggering condition is based on a collision determination that the second virtual object has or will collide with another one of the plurality of virtual objects.

18. The computing system of claim 11, wherein the update message includes an instruction to perform the dynamic action for the at least one second virtual object.

19. A non-transitory computer readable storage medium storing computer executable instructions for use with a computer system that includes at least one hardware processor, the stored computer executable instructions comprising instructions that are configured to cause the computer system to perform operations comprising:
storing object data for a plurality of virtual objects of a multiplayer video game, the plurality of virtual objects including a first participant controlled virtual object, a plurality of other participant virtual objects, and at least one second virtual object;
executing a client-side simulation for the multiplayer video game that includes the plurality of virtual objects in a virtual game space, the client-side simulation using the stored object data,
processing user input for controlling the first participant controlled virtual object;
receiving, from another computer system, video game update messages that include data for the plurality of other participant virtual objects and/or the at least one second virtual object;
updating the object data for the first participant controlled virtual object based on the processed user input;
updating the object data for the plurality of other participant virtual objects and/or the at least one second virtual object by interpolating positional data for the plurality of other participant virtual objects and/or the at least one second virtual object based on the video game update messages,
performing, as part of the client-side simulation, client-side collision processing for the plurality of virtual objects in a virtual game space, wherein a collision involving the at least one second virtual object is not included in the video game update messages; and
generating and outputting video game images based on the client-side simulation for the multiplayer video game.

20. The non-transitory computer readable storage medium of claim 19, wherein different objects among the plurality of other participant virtual objects and/or the at least one second virtual object are interpolated differently based on a type of virtual object.
